(19) United States
(12) Patent Application Publication
(10) Pub. No.: US 2006/0102480 A1
(43) Pub. Date: May 18, 2006

(54) Apparatus and methods for performing electrophoretic separations of macromolecules

(76) Inventors: Shaorong Liu, Lubbock, TX (US); Juan Lu, Lubbock, TX (US)

Correspondence Address: LIU, SHAORONG, 5504 71ST STREET, LUBBOCK, TX, 79424, US

(21) Appl. No.: 11/265,479

(22) Filed: Nov. 2, 2005

Related U.S. Application Data
(60) Provisional application No. 60/629,037, filed on Nov. 17, 2004.

(51) Int. Cl. B01D 57/02; G01N 27/447

(52) U.S. Cl. 204/455; 204/605

(57) ABSTRACT

Apparatus and methods are disclosed for performing electrophoretic separations of macromolecules, particularly protein and DNA molecules. Cross-linked polyacrylamide is used as a sieving matrix for the separations. As long as the cross-linking is properly controlled, the cross-linked polyacrylamide is replaceable and superior to linear polyacrylamide for electrophoretic separations of macromolecules.

This patent application claims the benefit under 35 U.S.C. § 119(e) of US provisional patent application Ser. No. 60/629,037, filed on Nov. 17, 2004.

### BACKGROUND OF THE INVENTION

1. Field of the Invention

The present invention relates generally to electrophoresis, and more particularly, to polymer-containing micro-columns for high performance analytical electrophoresis.

2. Description of Related Art

Sodium dodecyl sulfate-polyacrylamide gel electrophoresis (SDS-PAGE), which utilizes cross-linked polyacrylamide as a sieving matrix to determine the mass of denatured proteins in a slab-gel format, has been used for over three decades (Journal of Biological Chemistry, 1969, 244, 4406-4412). It is still the workhorse for protein separations and analyses in most laboratories. However, the technique is time-consuming and lab-intensive. Starting from gel preparation to densitometric measurement, it takes more than 8 h, and the major steps (e.g. the gel preparation, sample loading, staining, destaining, etc.) are all manual operations. Additionally, the technique is semi-quantitative when common stain techniques such as coomassie or silver staining are used. Furthermore, due to the many manual manipulations, the gel-to-gel reproducibility is poor, and complete automation is challenging albeit some of the steps have been automated. Capillary gel electrophoresis can potentially overcome all these problems, since it offers high separation speed, quantitative on-column detection and the potential for fully automated operations.

The first papers on capillary gel electrophoresis were published in the 1980s (Journal of Chromatography, 1987, 397, 406-417). As in slab-gels, cross-linked polyacrylamide was used as the sieving matrix, and it was directly prepared inside the capillary. Due to the gel shrinking during polymerization, these capillary columns usually suffer from bubble formation. In general, it is problematic to apply high field strengths across these columns to achieve reproducible and high-quality separations. In the early 1990's (Journal of Chromatography, 1990, 516, 33-48), a replaceable linear polyacrylamide was introduced to address this issue. Linear polyacrylamide was first prepared outside a capillary column, and it was then pressurized into the column before an electrophoretic separation was performed. Because the polymer was replaced after each run, the run-to-run reproducibility was improved. Many other replaceable polymers, such as dextran, polyethyleneoxide, pullulan, and hydroxypropyl cellulose, have been used in capillary gel electrophoretic separations. So far, the highest resolutions of SDS-capillary gel electrophoresis for proteins have been produced by using linear polyacrylamide and its derivatives (Analytical Chemistry, 2001, 73, 1207-1212).

Cross-linked polyacrylamide has not been investigated as a replaceable sieving matrix for SDS-capillary gel electrophoresis applications, possibly due to concerns about its high viscosity and its assumed non-replaceability. Interestingly, we have discovered that the cross-linked polyacrylamide is not only replaceable but also superior to linear polyacrylamide as long as the cross-linking is properly controlled. This replaceable cross-linked polyacrylamide is referred to as rCPA. The present invention provides such polymers, as well as methods of preparing and utilizing these polymers and systems employing these polymers for electrophoretic separations of macromolecules. Other related embodiments such as the use of surfactants different from SDS in a sieving matrix are also disclosed.

### SUMMARY OF THE INVENTION

The present invention generally provides novel apparatuses, methods and compositions for use in the separation of molecular, and particularly macromolecular species by electrophoretic means.

One aspect of the present invention uses a micro column filled with an rCPA for molecular separations. In one embodiment, the inner wall of the separation column is modified to suppress electroosmotic flow (EOF) and analyte adsorption. The modification is by either chemically binding a layer of molecules such as polyacrylamide, polyvinyl alcohol and their derivatives, or physically attaching a layer of molecules such as poly(ethylene oxide), hydroxy-ethyl cellulose, hydroxypropyl cellulose, and some surfactants to the wall surfaces.

In an additional embodiment, the rCPA contains 0.5% to 20% acrylamide, more preferably 1% to 10% acrylamide, more preferably 2% to 5% acrylamide. In another embodiment, the rCPA contains 0.001% C to 5% C (cross-linker, such as bisacrylamide and its derivatives), more preferably, 0.05% C to 2% C, more preferably 0.1% C to 1% C. The % C is defined as the percentage weight of the cross-linker to the weight of the monomer in the same solution.

In a separate embodiment, the SDS in a sieving matrix (e.g. linear polyacrylamide, replaceable cross-linked polyacrylamide, agrose gel, hydroxypropyl cellulose, hydroxyethyl cellulose, polyethyleneoxide, etc) is replaced by a different surfactant. The hydrophobic portion of the surfactant is different from that of SDS, preferably larger than that of SDS.

In another embodiment, an electric field is applied across the column to effect the separations. Yet in another embodiment, a detection scheme is attached near the end of but on the column for monitoring and measurement of the separated analytes. The detection scheme can be any one or a combination of the following detectors: an absorbance detector, a fluorescence detector, a conductivity detector, an electrochemical detector, refractive index detector, a light scattering detector, a radioactivity detector, and a mass spectrometer. The detector can also be attached near the end of but off the separation column.

In a separate embodiment, a sample injection scheme is affixed to the column to facilitate the sample introduction. In one specific embodiment, the sample injection scheme is a volumetric injector. Yet in another embodiment, the sample injection scheme is an electrokinetic injector. In another embodiment, the sample injection scheme is an injector that uses a pressure difference between two ends of a separation capillary.

In an additional embodiment, a temperature control system is incorporated with the separation column. The temperature control system has a temperature range of −10° C. to 100° C., more preferably 4° C. to 80° C.

In another embodiment, the column is micro-machined channel in a silica, a ceramic, or an alumina microfluidic device. In a separate embodiment, the column is micro-machined on a polymer chip. The polymeric materials include but not limit to polycarbonate, poly(methyl methacrylate); poly(dimethyl siloxane); poly(ethylene terephthalate); polystyrene, nitrocellulose, poly(ethylene terephthalate), and poly(tetrafluoroethylene).

### BRIEF DESCRIPTION OF THE DRAWINGS

FIG. 1. Effect of linear polyacrylamide concentration on protein separation. (a) Electropherograms of separations of protein markers. (b) Ferguson plots.

FIG. 2. Replaceable cross-linked polyacrylamide for protein separation.

FIG. 3. Resolution enhancement with cross-linker concentration.

FIG. 4. Effect of cross-linker concentration on separation efficiency. The plate numbers were calculated based on the separation peaks from FIG. 3.

FIG. 5. Replaceable cross-linked polyacrylamide for separation of real-world sample. (a) Electropherogram of a crude E. Coli cell extract sample; (b) Electropherogram of protein size markers.

FIG. 6. Calibration curves for protein size determination. Curve (b) was used in this report.

FIG. 7. Current change with time during separation.

FIG. 8. A schematic diagram of a device to load cross-linked polyacrylamide into a separation capillary.

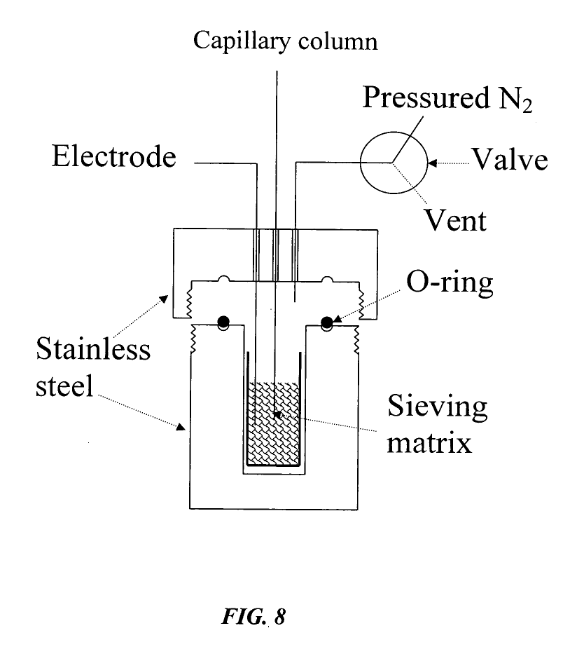

### DETAILED DESCRIPTION OF THE PREFERRED EMBODIMENTS

In-capillary polymerized linear polyacrylamide has been used for SDS-PAGE separation of proteins (Analytical Chemistry, 1992, 64, 2665-2671). Depending on the buffer systems and polymerization procedure selected, the monomer concentration varies but is usually above 8˜10%. This concentration needs to be reduced in order for the linear polyacrylamide to be replenishable in the separation column. In a US patent (U.S. Pat. No. 5,112,460), a replaceable linear polyacrylamide was disclosed for capillary electrophoresis. To determine the upper limit of this concentration, a series of linear polyacrylamide solutions were prepared, and tested for their replaceability through a 35-cm-long and 75-μm-ID capillary. Under a pressure of 80 psi, the linear polyacrylamide with a concentration of up to 6% were replaceable, although the loading time increased from<1 min for 2% linear polyacrylamide to ˜30 min for 6% linear polyacrylamide. With a concentration of >7%, the gel could no longer be pressurized into the capillary at the test pressure. Of course, the concentrations will increase if the molecular weight of the linear polyacrylamide reduces, and vise versa.

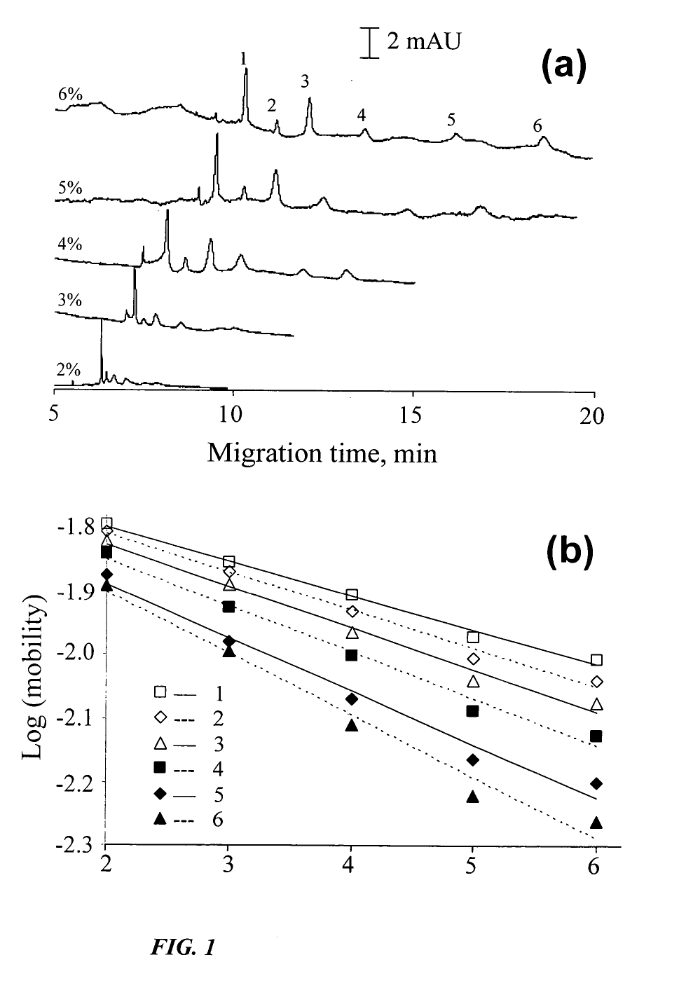

FIG. 1a presents separations of protein size markers using linear polyacrylamide at different concentrations. The separations were performed using a 75-μm-i.d., 200-μm-o.d., 34.5-cm-long (effective length: 30 cm) capillary. The capillary inner wall was coated with cross-linked polyacrylamide. The sample contained 1.9 μg total protein/μL and 3% SDS, 2% 2-Mercaptoethanol, and 0.06M Tris-0.06M TAPS at pH 8.35. The sample was electrokinectically injected at 290V/cm for 5 s. The separation was performed at the same field strength. The separated proteins were detected at 220 nm. Protein identification: 1-Lactalbumin (14.4 kD), 2-Trypsin inhibitor (20.1 kD), 3-Carbonic anhydrase (30 kD), 4-Ovalbumin (45 kD), 5-Albumin (66 kD), 6-Phosphorylase b (97 kD). As can be seen from FIG. 1a, both the resolution and the migration time increases with the linear polyacrylamide concentration. FIG. 1b presents the relationships between log(mobility) and the linear polyacrylamide concentration (the Ferguson plot). Good linear relationships were obtained for all six proteins. While increasing the linear polyacrylamide concentration improved the resolution, the separation times were extended and higher pressure was needed for linear polyacrylamide loading.

During the course of some other parallel experiments, it was necessary to increase the molecular weight of the linear polyacrylamide being used. We sought to achieve this by adding a small amount of cross-linker into the monomer solution. Of course, the product was a partially cross-linked polyacrylamide. Surprisingly, this cross-linked polyacrylamide solution was found to be flowable and could be conveniently pressurized through a 75-μm-ID capillary. A series of rCPA solutions containing 2.5% T and 0-1% C was then prepared and tested for protein separations. The % T is defined as the acrylamide concentration in the associated solution, and the % C is defined as the percentage of the weight of the cross-linker to the weight of the monomer in the same solution.

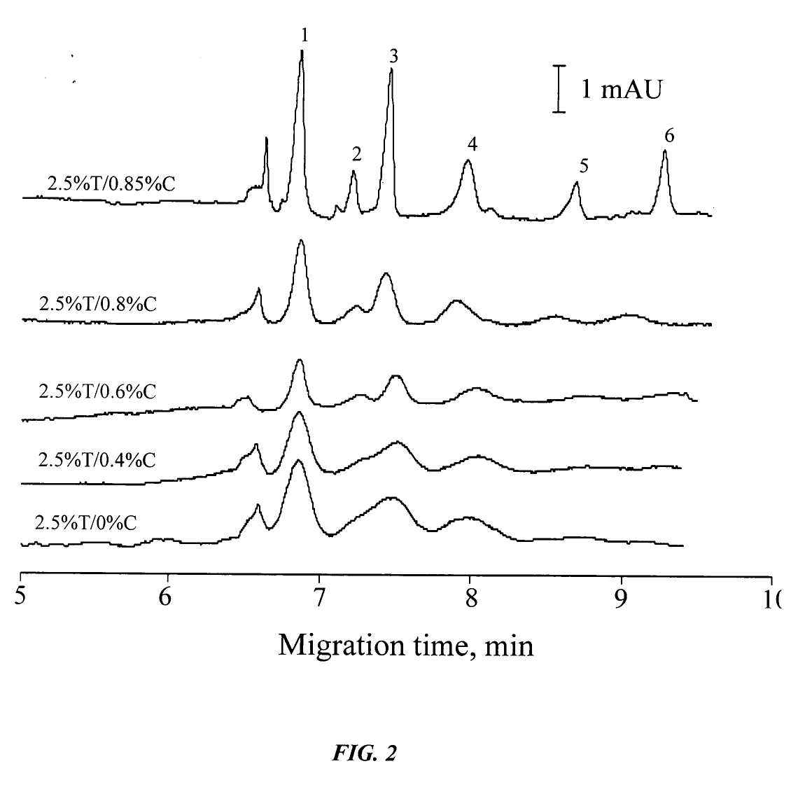

FIG. 2 shows the separations of a set of low molecular weight (MW) protein markers using various rCPA solutions. Other experimental conditions were identical to those for FIG. 1. From FIG. 2, two important features of rCPA were discovered: (a) the protein resolution improved considerably as the cross-linker concentration increases, and (b) the migration times of all the proteins were virtually unchanged, although the matrix viscosity increased from 26 cp for 2.5% T and 0% C to 664 cp for 2.5% T and 0.85% C. Generally speaking, as long as an rCPA can be pressurized into a separation column, it can be used for electrophoretic separations. Such an rCPA should have a viscosity of less than 500 N m⁻² s.

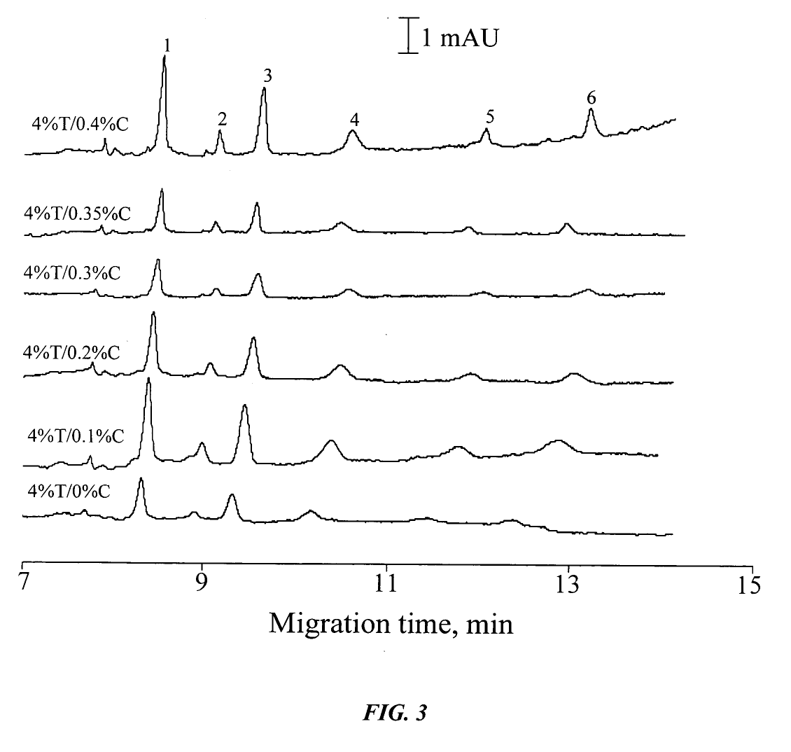

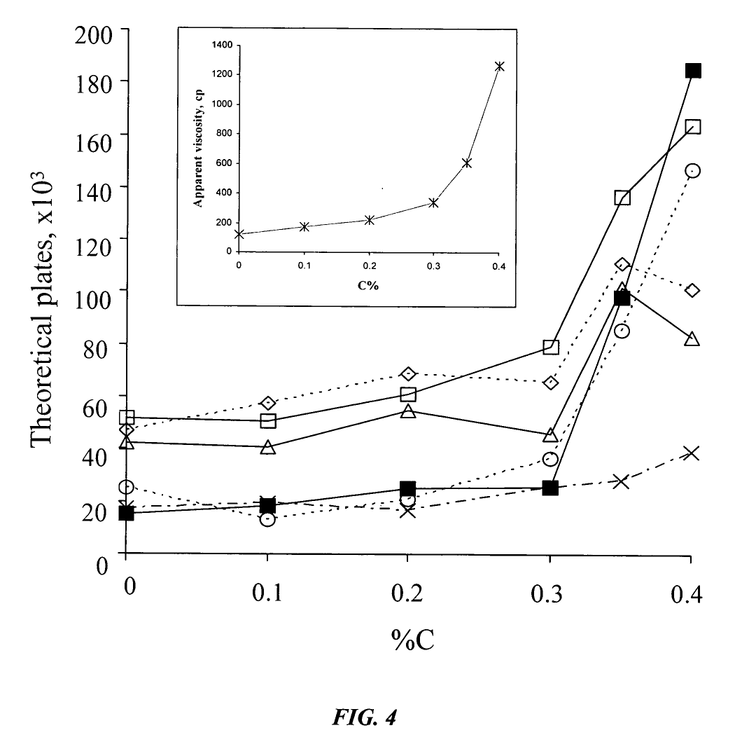

To optimize rCPA formulation for protein separations, various combinations of monomer and cross-linker concentrations were tested. FIG. 3 presents a typical set of electropherograms at 4% T and 0-0.4% C. In terms of the number of theoretical plates, the separation efficiency increased by a factor of ˜4-5 on average [see FIG. 4: ⋄-Lactalbumin (14.4 kD), □-Trypsin inhibitor (20.1 kD), Δ-Carbonic anhydrase (30 kD), ×-Ovalbumin (45 kD), ▪-Albumin (66 kD), ∘-Phosphorylase b (97 kD)], while the migration time increased less than 10% (see FIG. 3). The data in FIG. 4 suggest that the resolution of some of the proteins should be further improved if the cross-linker concentration is increased. Such matrices are difficult to be loaded into the separation capillary because the matrix viscosity increases exponentially with the cross-linker concentration (see inset, FIG. 4). It becomes common now that a high pressure nitrogen cylinder can provide a pressure of ˜6000 psi. With this kind of pressure, either acrylamide concentration or the cross-linker concentration may be increased to improve the separations.

The rCPAs tested had monomer concentrations ranging from 2.5-5% T and cross-linker concentrations from 0-0.85% C. Table 1 presents a separation efficiency comparison between

TABLE 1
Efficiency (plate number in thousands) comparison between the separations
using rCPA of 4% T and 0.45% C and rCPA of 2.5% T and 0.85% C.

| | | Trypsin | Carbonic | | | Phosphorylase |
|---|---|---|---|---|---|---|
| | Lactalbumin | inhibitor | anhydrase | Ovalbumin | Albumin | b |
| 4% T-0.45% C | 101 | 164 | 83 | 33 | 185 | 147 |
| 2.5% T-0.85% C | 66 | 104 | 86 | 29 | 89 | 113 |

rCPA of 4% T-0.4% C (the top trace in FIG. 3) and rCPA of 2.5%T and 0.85%C (the top trace in FIG. 2). On average, the plate number increased ˜20% for all six proteins, although the plate numbers for protein 3 were close. At a same separation speed, the resolutions obtained from rCPA were better than linear polyacrylamide. At the same resolutions, the separation speed using rCPA was faster than that using linear polyacrylamide. Compared to polyethyleneoxide and hydroxypropyl cellulose, two other popular sieving matrices for protein separations, rCPA produced improved resolutions with similar separation speeds.

For certain applications, removal of residual monomer and low molecular weight acrylamide polymers can improve the separations. This is true for both linear polyacrylamide and rCPA. In Example 4, a precipitation method was used to remove the residual monomer and low molecular weight acrylamide polymers. Other methods such as dialysis, chromatograph, extraction, precipitation, centrifugal force separation, field flow fractionation, and/or any combination of these separation techniques can also be used to carry out the removal.

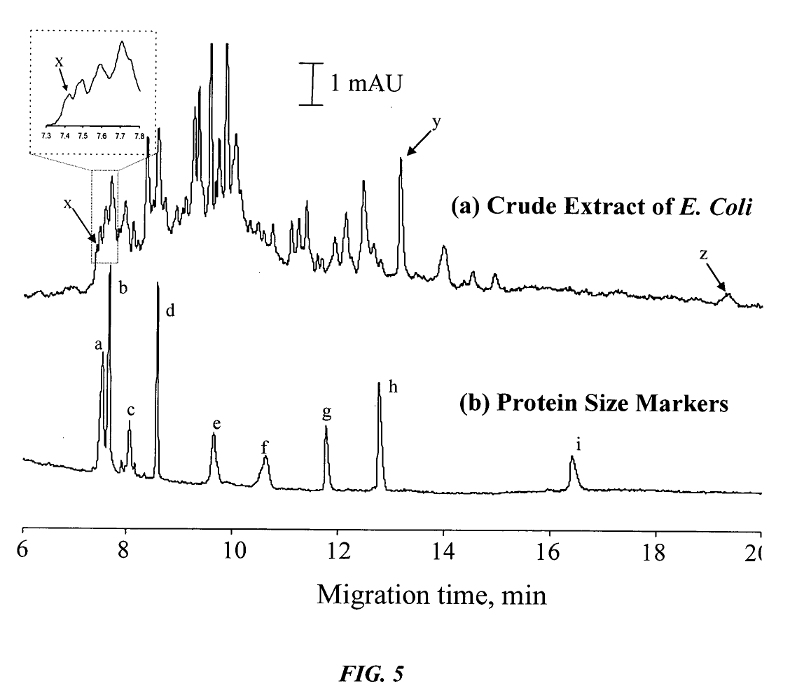

Using an rCPA with 4% T and 0.4% C, a crude E. Coli cell extract sample was separated [FIG. 5a: The cell extract sample was estimated to contain 6 μg total protein/μL. The protein marker sample contained 0.7 μg total protein/μL. Protein identifications: a-Aprotinin (6.5 kD), b-Lysozyme (14.4 KD), c-Trypsin inhibitor (21.5 kD), d-Carbonic anhydrase (31 kD), e-Ovalbumin (45 kD), f-Serum albumin (66.2 kD), g-Phosphorylase b (97.4 kD), h-β-galactosidase (116.25 kD) and i-Myosin (200 kD)]. Other experimental conditions were the same as for FIG. 1. The separation was stopped at 20 min, and more than 40 protein peaks were readily identifiable. Under the same experimental conditions, a set of broad MW protein markers was separated (FIG. 5b). Based on the protein marker, the majority of the proteins in the crude extract sample had MWs ranging from 4.2 kD (the peak labeled with X) to 259 kD (the peak labeled with Z).

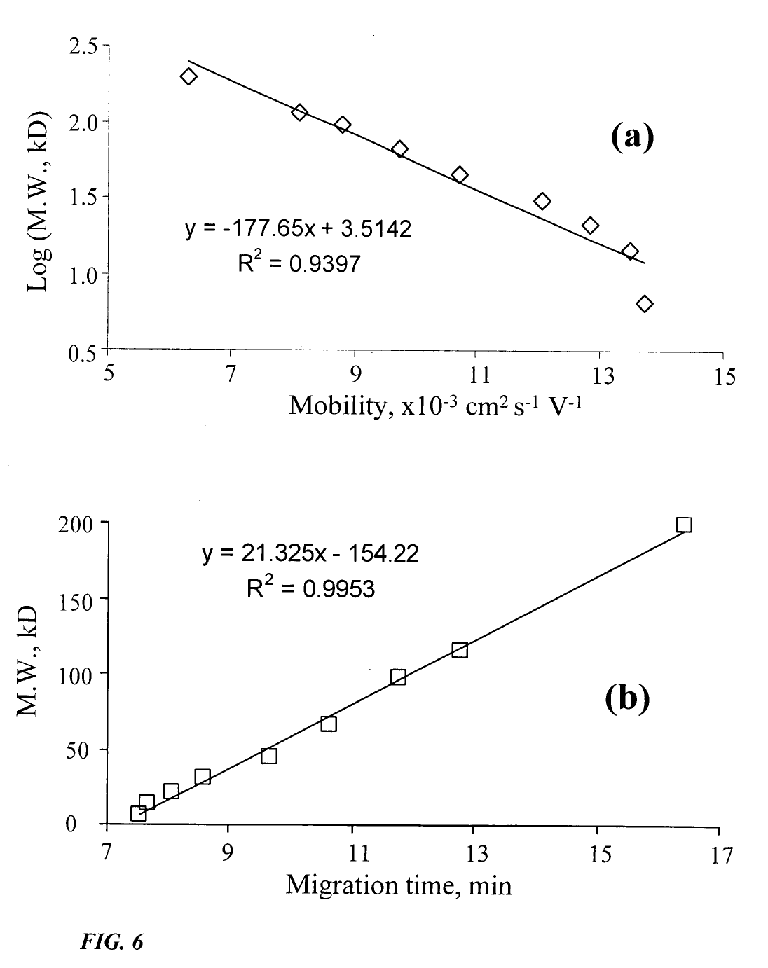

In SDS-PAGE, the protein MW is usually estimated based on a linear relationship between log(MW) and mobility. Such a linear relationship was obtained using 4% T and 0.4% C rCPA (FIG. 6a), with a linear coefficient of r²=0.9397 (r²=0.9911 with the data point for the smallest protein excluded). Interestingly, an even better linear relationship exists between MW and migration time (FIG. 6b, linear coefficient r²=0.9953). Using this curve, proteins X, Y and Z (referring to FIG. 5) had an MW of 4.2, 127, and 259 kD, respectively. Using the curve in FIG. 6a, the MW of Y and Z changed to 126 and 268 kD, reasonably close to the above results but predicted a negative MW for protein X. The curve in FIG. 6b would therefore appear to be the preferred mode for MW estimation.

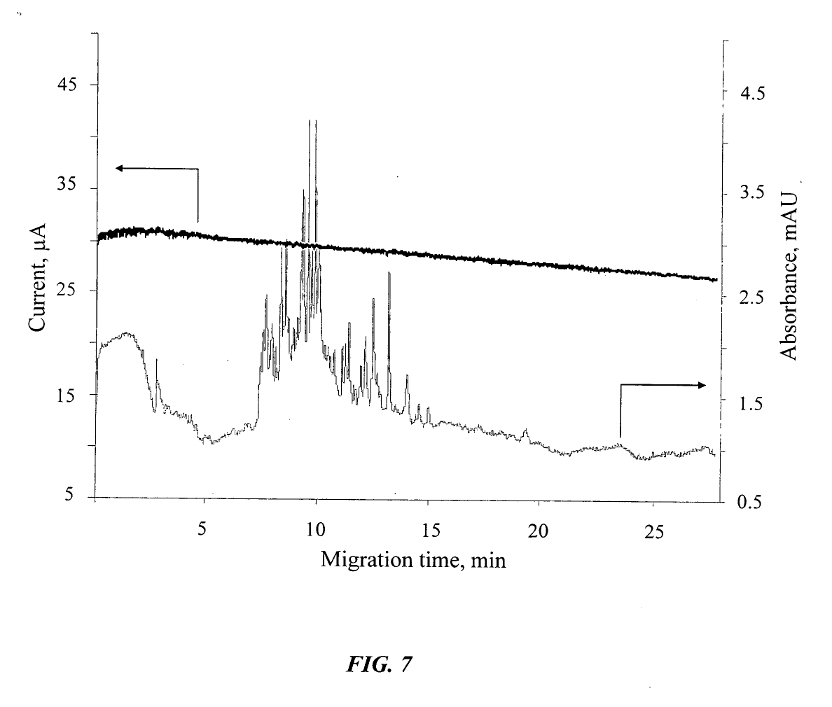

FIG. 7 presents the current change with time for the separation of E. Coli extract during the entire course of the experiment. The experimental conditions were identical to those for FIG. 5a. The absorbance signal of the separation was the same trace as that shown in FIG. 5a, and it was included in FIG. 7 to indicate the progress of the separation. The two traces were recorded simultaneously. As can be seen from FIG. 7, the current changed from the highest of ˜30 μA initially to the lowest of ˜27 μA at the conclusion of the experiment. The current magnitude, fluctuation level and variation trend are typical for all other separations. Current-breakdown was rarely a problem for these rCPAs under the indicated separation conditions.

In a matrix for SDS-PAGE, SDS is an essential component. When SDS binds to a protein molecule, it not only denatures the protein and makes the protein more soluble in water, but also charges the protein molecule with negative charges approximately proportional to its size. As a result, SDS-PAGE separates proteins based on their sizes. SDS has been used for more than three decades since its invention. Due to the nature of thermal dynamics, there exists an equilibrium between the SDS bonded to protein molecules and the SDS free in the aqueous solution. To ensure every protein molecule is saturated with SDS in order for the protein molecule to have a constant charge, one has to put sufficient SDS in the solution. Usually, several percent of SDS is added in the sample solution and the sieving matrix, and SDS is often one of the major electric current carriers in the solution. In capillary electrophoresis, the electric current is preferred to be low to reduce the Joule heating. We have discovered that, when other surfactants such as CₘH₂ₘ₊₁SO₃Na (where m>12) are used, the concentration of surfactants is significantly reduced and so is the electrophoresis current. We have used these surfactants (m=13˜18) in linear polyacrylamide and rCPA matrices for capillary gel electrophoresis and cross-linked polyacrylamide for slab-gel electrophoresis. These surfactants are certainly applicable to other matrix systems such as agrose, hydroxypropyl cellulose, hydroxyethyl cellulose, polyethyleneoxide, etc. It is possible that a combination of multiple surfactants in a sieving matrix may generate improved separation efficiencies and/or resolutions. Therefore, two or more surfactants will coexist in a sieving matrix.

The general formula of CₘH₂ₘ₊₁SO₃Na represents a saturated carbon chain for the hydrophobic portion of a surfactant. The hydrophobic portions can be either branched carbon chains or straight carbon chains. Un-saturated carbon chains (including aromatic moieties) can be part of the hydrophobic portions of the surfactants. Of course, the molecule formula will be different. For UV detection, un-saturated carbon chains will absorb light, which is often undesirable. For detection schemes such as fluorescence detection, un-saturated carbon chains may present advantages (e.g. stronger binding to certain proteins) over saturated carbon chains.

One major problem encountered for protein separations by capillary electrophoresis is the adsorption of proteins to capillary walls. The dominant mechanism of protein adsorptions is the electrostatic interaction between positively charged residues of the proteins and the negatively charged silica surfaces. Protein adsorption deteriorates the resolution and contributes to the irreproducibility of the separations. Either of the following approaches is often taken to prevent protein adsorptions: (a) dynamic coating by small ionic, zwitterionic, or nonionic molecules and especially by low concentrations of certain water-soluble nonionoic polymers, and (b) permanent coating with materials chemically bonded to the surface or otherwise immobilized as films on the capillary walls.

The dynamical coatings usually suffer from limited stability and require repeated replenishment for reproducible operations. As mass spectrometry (MS) becomes the dominant technique with which protein mixtures are studied, the use of dynamic coatings could be problematic because the dynamic coating additives often adversely affect the online MS analysis of proteins.

Permanent coatings are favored for protein separations since no additional materials are introduced to the sample solutions. One simple means to obtain a permanent coating is to attach a preformed polymer, such as poly(vinyl alcohols) (PVA) and hydroxypropyl cellulose (HPC), to the capillary wall. Two basic steps are involved in this coating process: (i) wetting the capillary wall with a solution containing the polymer and (ii) baking the capillary to immobilize the polymer to the wall. These steps can be repeated several times to ensure the polymer to cover the wall completely. However, the lifetimes of these coatings are usually limited.

More often, permanent coatings are obtained by covalently bonding the desired coating materials to the capillary walls. This coating protocol was first introduced by Hjerten in 1985 (Journal of Chromatography, 1985, 346, 265-270). Typically, the capillary wall is first derivatized with a bi-functional reagent, such as 3-(trimethoxysilyl) propyl methacrylate, leaving an acrylic group exposed on the wall surface. The capillary is then filled with a polymerizing solution containing a monomer, such as acrylamide, and polymerization initiator, such as potassium persulfate. The free acrylic groups attached to the capillary wall serve as anchors for growing linear polyacrylamide (LPA) chains. The major problem of this coating is that the LPA molecules cannot cover the capillary wall completely.

All the above coating schemes may be used for this invention. In one embodiment, the coating materials are selected from linear polyacrylamide, polymethylacrylamide, poly(dimethylacrylamide), cross-linked polyacrylamide, polyvinyl alcohol, poly(ethylene oxide), hydroxy-ethyl cellulose, hydroxypropyl cellulose, and their derivatives.

In one embodiment, the oxygen in the monomer solution needs to be removed, since it is a radical suppression reagent. Maintaining a constant concentration, preferably a low concentration of oxygen is a key to prepare rCPAs (and linear polyacrylamides as well) reproducibly. The degassing process is performed before polymerization reaction is initiated. After an rCPA is prepared, it is loaded into a separation column. A sample is then introduced into the separation column, a voltage is applied across the separation column, and the separated analytes are detected on or off the column by a detection scheme.

One aspect of the present invention uses a tubular column filled with a replaceable cross-linked polyacrylamide for molecular separations. In a specific embodiment, the separation column is a fused silica capillary, a microchannel in a microchip device, or a large diameter column for laboratory and industry scale preparative separations. Multiplexed capillary electrophoresis has been employed to boost the analysis throughput. The invented apparatus and methods can be applied for multiplexed capillary electrophoresis.

For analytical separations, the diameter of a separation column needs to be small, often less than 1 mm, more preferably less than 250 μm, and more preferably less than 100 μm. For preparative separations, the diameter will be much larger, ranging from one millimeter to several meters. For non-circular columns, the equivalent diameter can be calculated by d=2\sqrt{S/π}, where S represents the cross-section area of the associated column. One potential problem for employing large columns for electrophoretic separations is Joule heating. Low field strength may be used to overcome this problem. Alternatively, honeycomb-shaped columns (an array of parallel columns) may be used to address this issue. Also, some cooling mechanisms may be used to sink the heat.

In another embodiment, the detection scheme is an absorbance detector, a fluorescence detector, an electrochemical detector, refractive index detector, a light scattering detector, a radioactivity detector, a mass spectrometer, or any combinations of them.

In another embodiment, the walls that are in contact with rCPA are modified to suppress the EOF and analyte-wall interactions. Un-modified walls often interact with analyte molecules, which results in poor separation efficiencies. EOF is caused by the net charge on the walls. EOF is beneficial in certain occasions for capillary electrophoresis, because it brings the separated analytes to the detector. In other occasions, EOF is not good because it reduces the analytes' residency times in the capillary. Due to the fact that separations occur inside the capillary, reduced residency times mean diminished resolution. The wall-modification can be either chemically binding a layer of molecules such as polyacrylamide, polyvinyl alcohol and their derivatives, or physically attaching a layer of molecules such as poly(ethylene oxide) (polyethyleneoxide), Hydroxy-ethyl cellulose, Hydroxypropyl cellulose, polymethylacrylamide, poly(dimethylacrylamide), and some surfactants to the wall surfaces.

In an additional embodiment, the rCPA contains 0.5% T to 20% T, preferably 1% T to 10% T T, and more preferably 2% T to 5% T. In another embodiment, the rCPA contains 0.001% C to 20% C, preferably 0.05% C to 5% C, and more preferably 0.1% C to 1% C. The cross-linker is a chemical reagent capable of cross-linking polyacrylamide molecules during polymerization reaction. An example of such cross-linkers is bisacrylamide. Many of its derivatives can also be used as a cross-linking reagent.

In a particular embodiment, the rCPA is pressurized into a separation column.

In a separate embodiment, after the replaceable polyacrylamide is prepared, the polymers are purified by removing the residual monomer and the low molecular weight polymers. The purification methods include but not limited to dialysis separation, chromatographic separation, extraction separation, precipitation separation, centrifugal force separation, field flow fractionation separation, and/or any combination of these separation techniques.

In another embodiment, an electric field is applied across the column filled with an rCPA to effect the separations. In a particular embodiment, a detection scheme is attached near the end of but on the column for monitoring and measurement of the separated analytes. The detection scheme can be any one or a combination of the following detectors: an absorbance detector, a fluorescence detector, a conductivity detector, an electrochemical detector, refractive index detector, a light scattering detector, a radioactivity detector, and a mass spectrometer. The detector can also be attached near the end of but off the separation column.

In a separate embodiment, a sample injection scheme is affixed to the column to facilitate the sample introduction. In one specific embodiment, the sample injection scheme is a volumetric injector which introduces a pre-set volume of sample into a separation column reproducibly. In another embodiment, the sample injection scheme is an electrokinetic injector. The amount of analyte injected will depend on the electric field strength across the column and the injection time.

In an additional embodiment, a temperature control system is incorporated with the column. The temperature control system has a temperature ranging from −10° C. to 100° C., more preferably ranging from 4° C. to 80° C. A temperature gradient along the separation column and/or a temperature gradient with the separation time (at a constant or a varying ramping rate) may be also used to improve the separation efficiency and/or separation speed.

In another embodiment, the capillary column is a micro-machined channel in a silica, a ceramic, or an alumina microfluidic device. In a separate embodiment, the column is micro-machined on a polymer chip. The polymeric materials include but not limit to polycarbonate, poly(methyl methacrylate); poly(dimethyl siloxane); poly(ethylene terephthalate); polystyrene, nitrocellulose, poly(ethylene terephthalate), and poly(tetrafluoroethylene).

In a separate embodiment, one or more surfactants are added in a sieving matrix to partially or completely replace SDS. The sieving matrix contains linear polyacrylamide, rCPA, agrose, hydroxypropyl cellulose, hydroxyethyl cellulose, and/or polyethyleneoxide.

In order to illustrate the present invention, the following examples are provided. Although very specific experimental conditions are given in each example, these parameters may not be the best for specific applications. Varying the magnitude of some or all of the parameters is within the scope of the invention. Replacing one or more of the reagents with other reagents with similar functions is also within the scope of this invention.

### EXAMPLE 1

Preparation of cross-linked polyacrylamide coating. The capillary inner wall was activated by flushing a 1.0 M NaOH solution for ˜1 h, followed by rinsing with water and acetonitrile. After being dried with helium, the activated wall was reacted with a 4% bi-functional reagent [(3-Methacryloxypropyl)-Trimethoxysilane] for ˜1 h, rinsed with acetonitrile and dried with helium. The capillary was then flushed with a degassed solution containing 4% T and 2% C, 0.1% (v/v) TEMED (N,N,N′,N′-Tetramethylethylenediamine) and 0.01% APS (ammonium persulfate) at ˜0° C. for 8 min, and then flushed with water for 2˜3 min.

### EXAMPLE 2

Preparation of linear polyacrylamide solutions. Appropriate amount of acrylamide was dissolved in 1.5 mL solution containing 0.12 M Tricine, 0.042 M Tris and 0.25% SDS. After ˜1 min vacuum degassing, the polymerization reaction was initiated by adding 5 μL of 10% APS and 1 μL of TEMED in the vial, and the reaction was allowed to proceed overnight at room temperature.

### EXAMPLE 3

Preparation of rCPA solution-1. An rCPA solution was prepared in a 4-mL vial by dissolving an appropriate amount of acrylamide and bis [N,N′-Methylene Bisacrylamide] in 1.5 mL of a buffer solution containing 0.12M Tricine, 0.042M Tris and 0.25% SDS. After the solution was vacuum degassed for ˜1 min, polymerization reaction was initiated by adding 5 μL of 10% APS and 1 μL of TEMED in the vial. The reaction was allowed to proceed overnight at room temperature.

### EXAMPLE 4

Preparation of rCPA solution-2. Appropriate amount of acrylamide and Bis were dissolved in 100 mL of 1% aqueous IPA (isopropanol). The solution was filtrated through a 0.45-μm-pore-size filter. The filtrate was collected in a 250 mL Erlenmeyer flask with a septum cap. After a magnetic stir bar was placed in the solution, the solution was purged with He gas for 1 hr while stirring. The polymerization reaction was performed at room temperature by: adding 10 μL TEMED, 200 μL 10% APS solution into the acrylamide solution while purging and stirring. After the reaction was preceded for ˜15 minutes, the solution purging was stopped while the headspace purging continued. After ˜1 hr, the headspace purging was stopped, and the polymerization reaction was allowed to continue at room temperature overnight while stirring slowly.

The resulting polymer solution was transferred to a 500 mL beaker. About 100 mL ethanol was gradually added in a beaker while stirring. The rCPA was allowed to precipitate. After ˜30 minutes, the supernatant was decanted. The precipitate was washed with ˜60 mL. The precipitate and ethanol mixture was gently stirred for about 30 minutes before the supernatant was decanted. The washing process was performed again. The rCPA was then washed with 50 mL acetone twice, similar to that with ethanol. The precipitate was then dried with nitrogen or dry air. The final weight of the dry precipitate was used to calculate the yield. Normally, a yield of 80˜90% was obtained.

Appropriate amount of dry rCPA was weighted and put into a bottle with a septum cap. Appropriate amount of pre-prepared buffer solution (e.g., 0.12M Tricine-0.042M Tris pH 7.6 buffer, with 0.25% SDS and 1% IPA for a typical SDS-PAGE capillary gel electrophoresis) was added in the bottle. The bottle was capped and a vacuum was applied for 10˜20 minutes to remove the bubbles in the polymer. The solution was then placed on hot plate at 40˜50° C., with periodic stirring until a smooth and uniform gel solution was obtained. The re-dissolution usually took 5˜10 hours.

### EXAMPLE 5

Capillary SDS-PAGE. After a sieving matrix was introduced into a separation capillary by pressure, a protein sample was electrokinectically injected with a field strength of 290 V/cm for 5 s. The same sieving matrix solution was utilized as the background electrolyte solution in both anode and cathode reservoirs. The separation was also performed at the same field strength of 290 V/cm across the capillary. The separated proteins were detected with a UV absorbance detector at 220 nm. The matrix in the capillary was replenished after each run, while the matrix solutions in the reservoirs were used for 5-10 runs.

We claim:

1. An apparatus for high-resolution and reproducible electrophoresis, comprising:
a substrate having at least one capillary channel disposed therein, said capillary channel having an interior cavity and a wall with an inner surface;
a layer of coating material attached to said inner surface of said wall;
a polymeric gel filling said interior cavity, said polymeric gel comprises polymerized cross-linked monomer capable of being pressurized into said interior cavity; and
a voltage source capable of providing a voltage gradient along the length of said capillary channel.

2. The apparatus of claim 1, wherein said polymeric gel comprises polymerized cross-linked acrylamide.

3. The apparatus of claim 1, wherein said polymeric gel comprises polymerized cross-linked acrylamide with an acrylamide concentration between 0.5% T to 20% T.

4. The apparatus of claim 1, wherein said polymeric gel comprises polymerized cross-linked acrylamide with an acrylamide concentration between 1% T to 10% T.

5. The apparatus of claim 1, wherein said polymeric gel comprises polymerized cross-linked acrylamide with an acrylamide concentration between 2% T to 5% T.

6. The apparatus of claim 1, wherein said polymeric gel comprises polymerized cross-linked acrylamide with a cross-linker concentration between 0.05% C to 5% C.

7. The apparatus of claim 1, wherein said polymeric gel comprises polymerized cross-linked acrylamide with a cross-linker concentration between 0.1% C to 1% C.

8. The apparatus of claim 1, wherein said layer of coating material is covalently bonded to said inner surface of said wall.

9. The apparatus of claim 1, wherein said layer of coating material is selected from linear polyacrylamide, polymethylacrylamide, poly(dimethylacrylamide), cross-linked polyacrylamide, polyethyleneoxide, hydroxypropyl cellulose, hydroxyethyl cellulose, and their derivatives.

10. The apparatus of claim 1, wherein said substrate is a fused silica capillary.

11. The apparatus of claim 1, wherein said substrate comprises a plurality of capillary channels.

12. The apparatus of claim 1, wherein said substrate is selected from a glass material, a ceramic material, an alumina material, a polycarbonate material, a poly(methyl methacrylate) material, a poly(dimethyl siloxane) material, a poly(ethylene terephthalate) material, a polystyrene material, a nitrocellulose material, a poly(ethylene terephthalate) material, and a poly(tetrafluoroethylene) material.

13. The apparatus of claim 1 further comprises a detector selected from an absorbance detector, a fluorescence detector, a conductivity detector, an electrochemical detector, refractive index detector, a light scattering detector, a radioactivity detector, and a mass spectrometer.

14. A method of separating macromolecules by capillary electrophoresis, comprising:
providing a substrate having at least one capillary channel disposed therein, said capillary channel having an interior cavity and a wall with an inner surface;
attaching a layer of coating material to said inner surface of said wall;
pressurizing a polymeric gel into said interior cavity of the capillary channel, said polymeric gel comprises polymerized cross-linked monomer;
introducing a sample containing the macromolecules into one end of said capillary channel; and
applying a voltage gradient across the length of said capillary channel, whereby the macromolecules in the sample are separated in the channel.

15. The method of claim 14, wherein said polymeric gel in the pressurizing step comprises polymerized cross-linked acrylamide with an acrylamide concentration between 1% T to 10% T.

16. The method of claim 14, wherein said polymeric gel in the pressurizing step comprises polymerized cross-linked acrylamide with a cross-linker concentration between 0.05% C to 5% C.

17. The method of claim 14, wherein said layer of coating material in the attaching step is selected from linear polyacrylamide, polymethylacrylamide, poly(dimethylacrylamide), cross-linked polyacrylamide, polyethyleneoxide, hydroxypropyl cellulose, and hydroxyethyl cellulose.

18. The method of claim 14, wherein said substrate in the providing step is a fused silica capillary.

19. The method of claim 14, wherein said substrate in the providing step is selected from a glass material, a ceramic material, an alumina material, a polycarbonate material, a poly(methyl methacrylate) material, a poly(dimethyl siloxane) material, a poly(ethylene terephthalate) material, a polystyrene material, a nitrocellulose material, a poly(ethylene terephthalate) material, and a poly(tetrafluoroethylene) material.

20. An apparatus for separating macromolecules by capillary electrophoresis, comprising:
a substrate having an interior cavity;
a polymeric gel filling the interior cavity, said polymeric gel comprises at least a polymerized monomer and a surfactant having a general formula of CₘH₂ₘ₊₁SO₃Na, wherein the m in said formula is larger than 12.
a voltage source capable of providing a voltage gradient across the interior cavity filled with said polymeric gel.
